(19) United States
(12) Patent Application Publication
(10) Pub. No.: US 2010/0032955 A1
(43) Pub. Date: Feb. 11, 2010

(54) MOBILE WIND POWER GENERATING DEVICE

(76) Inventor: Shih H. CHEN, Yongkang City (TW)

Correspondence Address: HDLS Patent & Trademark Services, P.O. BOX 220746, CHANTILLY, VA, 20153-0746, US

(21) Appl. No.: 12/186,643

(22) Filed: Aug. 6, 2008

(51) Int. Cl. F03D 9/00; F03D 11/04

(52) U.S. Cl. 290/55

(57) ABSTRACT

A small mobile wind power generating device includes a plurality of foldable wind power generating modules installed in a box. The wind power generating module is composed of a plurality of wind power generating units, and connected to the bottom of the box by a contractible support rod, and a wheel module is installed at the bottom of the box for facilitating the moving of the wind power generating device. When the wind power generating device is not in use, the contractible support rod is contracted to fold and store the wind power generating modules into the box. When the wind power generating device is used, the contractible support rod is extended, such that the wind power generating modules can be taken out from the box and spread open for performing wind power generation.

### BACKGROUND OF THE INVENTION

1. Field of the Invention

The present invention generally relates to a wind power generating device, and more particularly to a small mobile wind power generating device.

2. Description of Prior Art

Since oil is extracted and used extensively all over the world, its total storage is lesser and lesser, and the price becomes increasingly higher. Furthermore, a carbon dioxide discharge resulted from the use of petroleum is a major factor of ozone layer depletion and greenhouse effect. With the consideration of climate change and environmental protection, recycling energy is a key point of establishing policies on the development of energy in the future, since the recycling energy has the features of clean, low green house gas discharge, and indigenous energy, and thus wind power generation has been listed as an option of developing recycling energy. The recycling energy is not produced by a consumption of matters and has the clean pollution-free feature, and its source comes from non-exhaustive natural winds, and thus recycling energy is an alternative energy aggressively developed by the industry now.

In general, a conventional generator for wind power generation is installed at a fixed site, and the assembling of vanes and fixed frames involves a complicated procedure, and the conventional generator for wind power generation incurs a high construction cost and requires a large area and a complicated installation, and the conventional generator has the drawbacks of a high installation cost and insufficient sites in cities and suburbs, places that require the construction, or even remote areas of underdeveloped countries. Secondly, a wind power generation site is usually far from users, and the long transmission distance generally causes a loss of electric power. Therefore, developing a mobile wind power generating device to reduce a loss of the distributed power demands immediate attentions and feasible solutions.

### SUMMARY OF THE INVENTION

It is a primary objective of the present invention to provide a mobile wind power generating device that can be moved to a place that requires an electric power.

Another objective of the present invention is to provide a high-efficiency mobile wind power generating device.

To achieve the foregoing objectives, the present invention installs a plurality of foldable wind power generating modules in a box, and each wind power generating module is composed of a plurality of wind power generating units. A contractible support rod is connected to the bottom of the box, and a wheel module is installed at the bottom of the box for facilitating the transportation of the wind power generating device. When the wind power generating device is not in use, the contractible support rod is contracted for folding and storing the wind power generating modules into the box easily. When the wind power generating device is used, the contractible support rod is extended, and the wind power generating modules are taken out from the box and spread open for wind power generation, so that electric energy generated by the wind power generating modules is stored into an electric power storage unit connected to the wind power generating modules for supplying electric power to a place where electric power is needed.

### BRIEF DESCRIPTION OF DRAWINGS

FIG. 1 is a perspective view of a spread-open wind power generating device in accordance with the present invention;

FIG. 2 is an exploded view of a portion of a wind power generating module in accordance with the present invention;

FIG. 3 is a schematic view of folding and storing a wind power generating module in accordance with the present invention;

FIG. 4 is a schematic view of a folded and stored wind power generating module in accordance with the present invention;

FIG. 5 is a schematic view of moving a wind power generating module in accordance with the present invention;

FIG. 6 is a schematic view of using a wind power generating module in accordance with the present invention; and

FIG. 7 is a perspective view of another preferred embodiment of the present invention.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the invention.

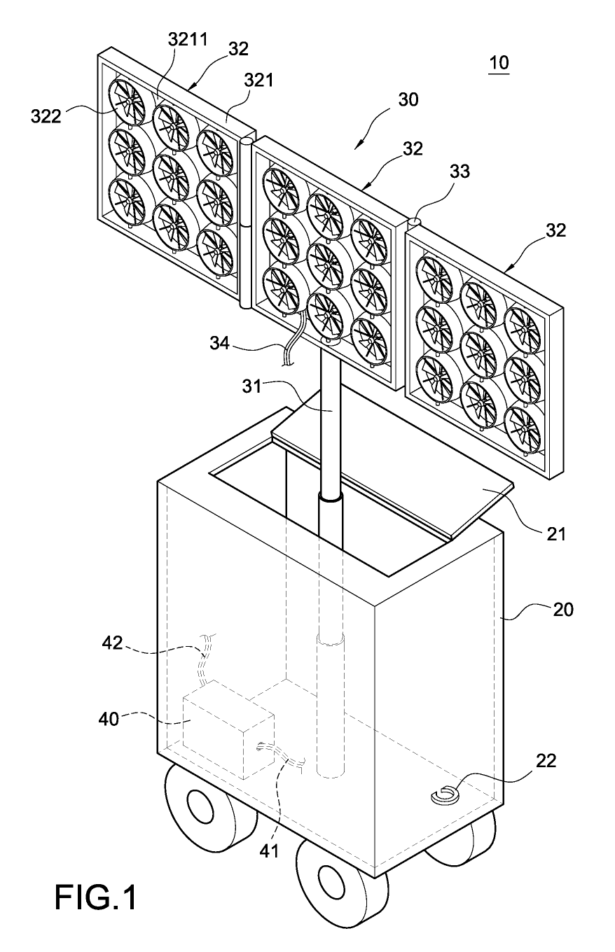

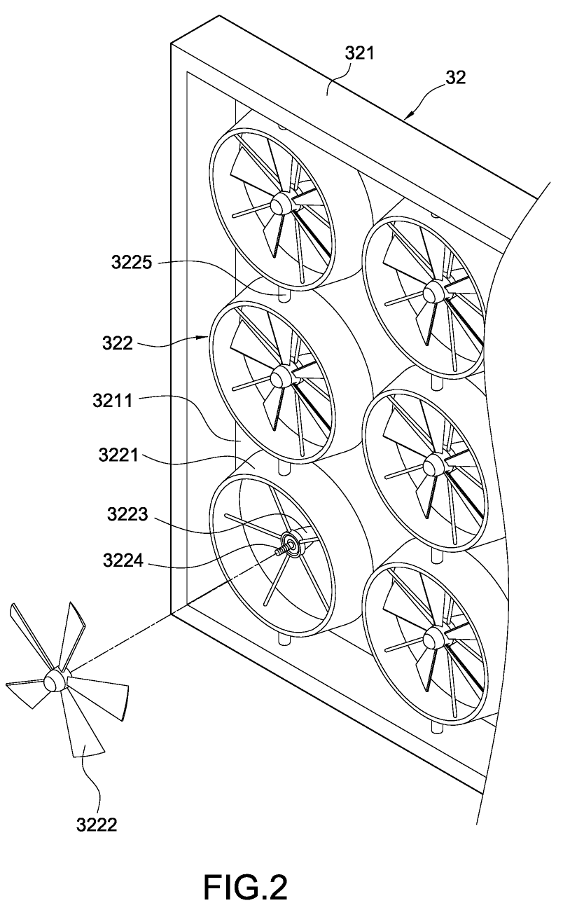

With reference to FIGS. 1 and 2 for a perspective view and a partial exploded view of a wind power generating module of the present invention respectively, the mobile wind power generating device 10 comprises a box 20, a wind power generating wall 30 and an electric power storage unit 40, and the box 20 includes a cover 21. In this embodiment, the box 20 includes a moving wheel module installed at the bottom, but it can be a car cabinet without wheels, and the box 20 includes a fixed support stand installed and fixed at the bottom for improving its stability, and a pull ring 22 disposed at the front of the box 20 for moving the wind power generating device 10 to a desired installation position.

The wind power generating wall 30 includes a contractible support rod 31 and at least one wind power generating module 32, and the contractible support rod 31 is installed in the box 20 and connected to the wind power generating module 32, such that the contractible support rod 31 can be extended out from the box or contracted into the box 20, and the wind power generating module 32 can be folded and stored into the box 20 or taken out from the box 20 and spread open. In this embodiment, a pivot shaft 33 is movably connected to three wind power generating modules 32, and the three wind power generating modules 32 and a contractible support rod 31 constitute a wind power generating wall 30. Further, a plurality of wind power generating walls 30 are installed to improve the electric power generating efficiency. For example, two contractible support rods 31 are installed in the box 20, and each contractible support rod 31 can support a different number of wind power generating modules 32, and the wind power generating walls 30 can be installed according to actual needs.

In the foregoing structure, the wind power generating module 32 comprises a base 321 and a plurality of wind power generating units 322, and the base 321 is connected to the contractible support rod 31 and forms a through hole 3211 for installing the plurality of wind power generating units 322. The wind power generating unit 322 further comprises a wind-guide hood 3221 (which is in a cylindrical shape in this embodiment, and it is not necessary to have the wind-guide hood or set it into other form), a direction-shafting pivot shaft 3225 serving as a support stand, a vane wheel 3222, a generator 3223 and an axle 3224 with both ends coupled to the vane wheel 3222 and the generator 3223 respectively. If wind is blows in a direction towards the through hole 3211 of the base, the vane wheel 3222 and the axle 3224 of the wind power generating unit 322 will be rotated, such that the generator 3223 will generate electric energy. The wind-guide hood 3221 can be rotated by the direction-shifting pivot shaft 3225 to shift the direction towards the windward side, so as to improve the power generation efficiency of the wind power generating unit 322. Finally, the electric energy will be transmitted to a conducting wire 34 connected to the wind power generating module 32.

The electric power storage unit 40 is installed onto a side of the bottom of the contractible support rod 31 in the box 20. In this embodiment, the electric power storage unit 40 includes an electric charger for converting the electric energy produced by the wind power generating module 32 into DC power to charge a battery, and a group of inverters are used for converting battery power into AC power to be outputted to a using end, and the electric power storage unit 40 is connected to a conducting wire 41, 42 electrically coupled to a conducting wire 34 of the wind power generating module 32 for inputting the electric energy produced by the wind power generating module 32 into the electric power storage unit 40, and the other conducting wire 42 is provided for stabilizing the supply of electric energy.

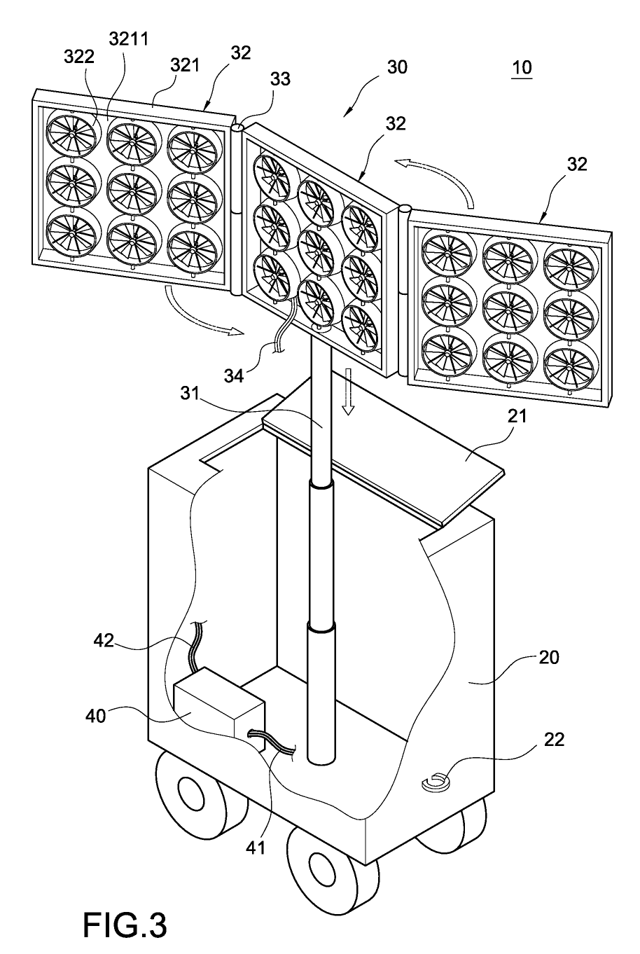

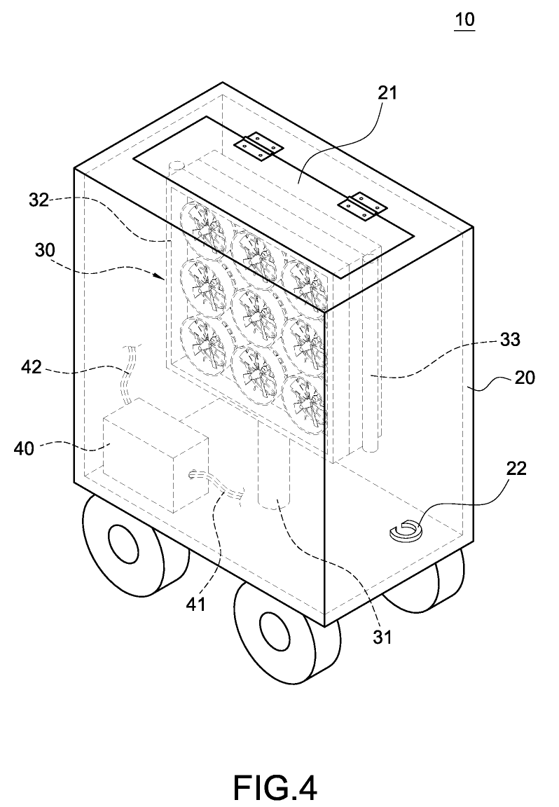

With reference to FIGS. 3 and 4 for schematic views of folding and storing a wind power generating module, and the folded wind power generating module in accordance with the present invention respectively, the contractible support rod 31 is contracted into box 20, when it is necessary to fold and store the wind power generating wall 30 into the box 20. With the pivot shaft 33, the plurality of movably connected wind power generating modules 32 can be folded and stacked with each other, so that the plurality of wind power generating modules 32 can be stacked into several layers and stored in the box 20, and the cover 21 is closed before moving the wind power generating device to other places.

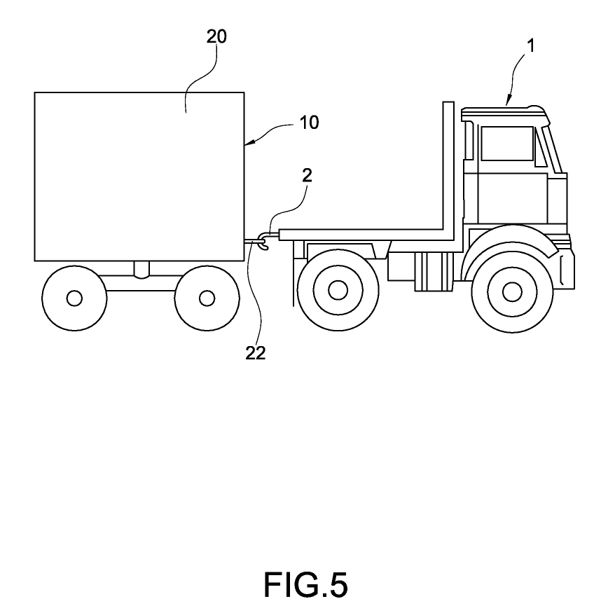

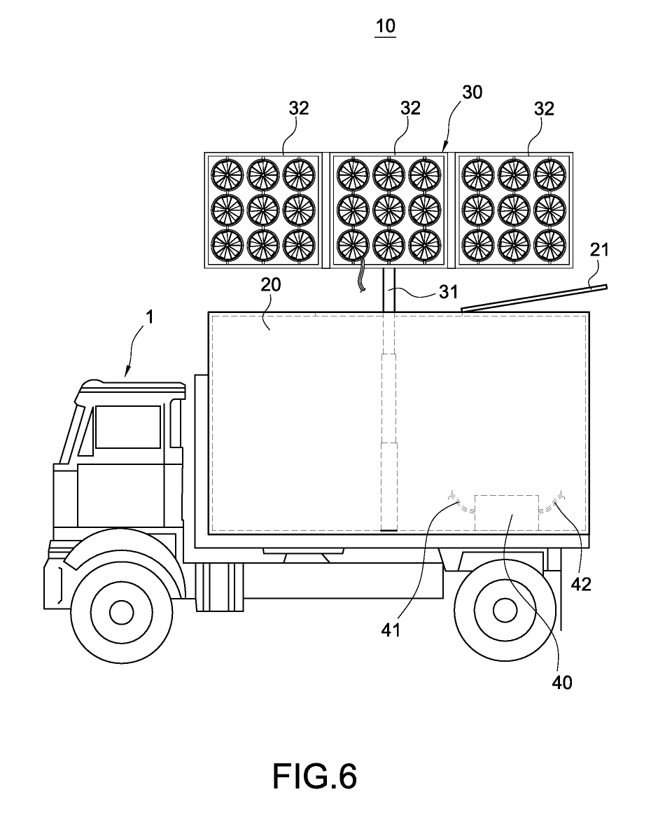

With reference to FIGS. 5 and 6 for schematic views of moving and using the wind power generating device in accordance with the present invention respectively, the pull ring 22 disposed at the front of the box 20 is connected to a lock hook at an automobile front end 1 when the mobile wind power generating device 10 is moved. If the box 20 is a car cabinet without wheels, a hydraulic jack is moved to a platform first, and then the automobile front end 1 is moved to a chassis behind the automobile front end 1, such that the mobile wind power generating device 10 can be moved to a desired position. When arriving the destination, the mobile wind power generating device 10 on the chassis can be used directly, or the box 20 is unloaded onto a floor before using the mobile wind power generating device 10. After the cover 21 of the box 20 is opened, the contractible support rod 31 is pulled and extended, and then the movably folded wind power generating modules 32 are spread open for users to start using the wind power generating module 32 and input the produced electric energy into the electric power storage unit 40, and finally output the electric energy stably.

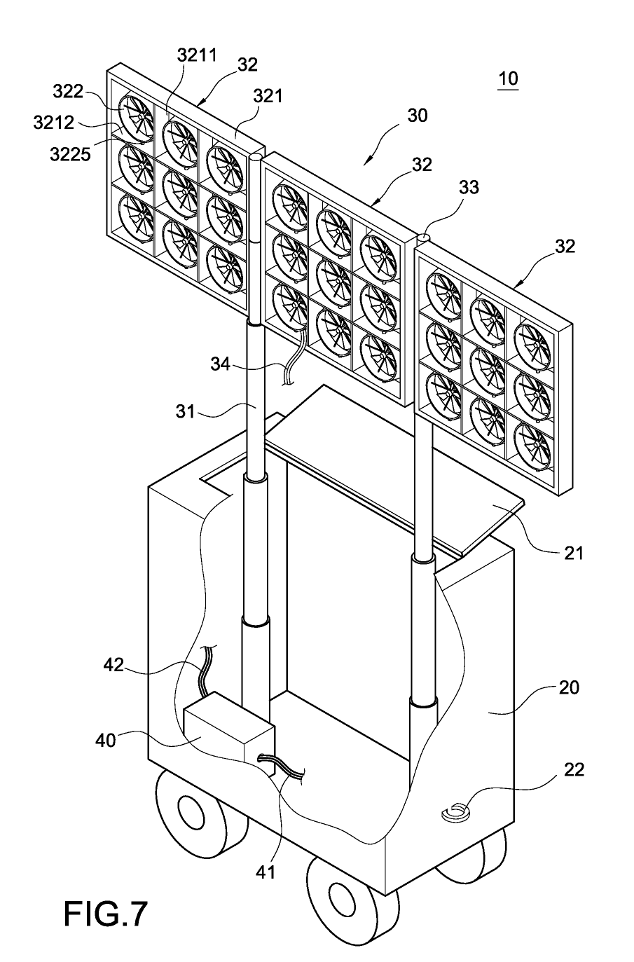

With reference to FIG. 7 for another preferred embodiment of the present invention, this embodiment is substantially the same as the embodiment described above, and the differences reside on that the wind power generating module 32 of this embodiment includes a support board 3212 for partitioning each wind power generating unit 322 and providing a support force, and thus each wind power generating unit 322 in each through hole 3211 partitioned by the support board 3212 can be turned towards the windward side by the direction-shifting pivot shaft 3225, and the contractible support rod 31 is installed on a side of the base 321 or between the wind power generating modules 32, such that the contractible support rod 31 can be contracted to lower the wind power generating module 32 to the internal bottom of the box 20 and maximize the usable space of the box 20. In addition, the wind power generating module 32 includes but not limited to a support board 3212, and modifications can be made as required in practical applications.

Therefore, the mobile wind power generating device of the invention is installed in a box, and the mobile wind power generating device comprises a wind power generating wall composed of a plurality of wind power generating modules and a contractible support rod. Since the wind power generating modules can be folded, stored or spread open in the box and wheels are installed at the bottom of the box, the wind power generating wall can be moved to a desired place for supplying electric power, and the invention improves the convenience and practicability of the wind power generating device. Further, the direction-shifting wind power generating units and the wind power generating walls in the box improves the electric power generating efficiency.

While the invention is described by way of examples and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. A mobile wind power generating device, comprising:
a box;
a wind power generating wall, including a contractible support rod and at least one wind power generating module, and the contractible support rod being disposed at an internal bottom of the box and connected to the wind power generating module, such that when the contractible support rod is contracted, the wind power generating module is folded into the box, and when the contractible support rod is extended, the wind power generating module is spread open for carrying out a wind power generation; and
an electric power storage unit, installed in the box, and electrically connected to the wind power generating module, for storing electric energy generated by the wind power generating module.

2. The mobile wind power generating device of claim 1, wherein the box includes a cover.

3. The mobile wind power generating device of claim 1, wherein the wind power generating wall further includes a pivot shaft, and two or more wind power generating modules movably coupled by the pivot shaft.

4. The mobile wind power generating device of claim 1, wherein the box is a car cabinet a pull ring disposed at the front of the car cabinet.

5. The mobile wind power generating device of claim 1, wherein the wind power generating module includes a base, a plurality of wind power generating units and a conducting wire, and the base is coupled to the contractible support rod, and the base forms a through hole thereon for installing the plurality of wind power generating units, and the conducting wire is electrically coupled to the electric power storage unit.

6. The mobile wind power generating device of claim 5, wherein the wind power generating unit includes a wind-guide hood, a direction-shifting pivot shaft, a vane wheel, a generator and an axle with both ends coupled to the vane wheel and the generator respectively.

7. The mobile wind power generating device of claim 1, wherein the electric power storage unit includes a battery, an electric charger and an inverter.

8. The mobile wind power generating device of claim 5, wherein the wind power generating module includes a support board installed therein for partitioning each wind power generating unit and providing a support force.
